(19) United States
(12) Patent Application Publication
(10) Pub. No.: US 2013/0027276 A1
(43) Pub. Date: Jan. 31, 2013

(54) ANTENNA DEVICE FOR SUPPORTING A PLURALITY OF BANDS IN A PORTABLE TERMINAL

(71) Applicants: Hee-Jun KWON, Seoul (KR); Yong-Sung JANG, Gyeonggi-do (KR)

(72) Inventors: Hee-Jun KWON, Seoul (KR); Yong-Sung JANG, Gyeonggi-do (KR)

(73) Assignee: SAMSUNG ELECTRONICS CO., LTD., Gyeonggi-Do (KR)

(21) Appl. No.: 13/404,864

(22) Filed: Feb. 24, 2012

(30) Foreign Application Priority Data
Jul. 28, 2011 (KR) 10-2011-0074909

(51) Int. Cl. H01Q 1/10; H01Q 1/36

(52) U.S. Cl. 343/883; 343/895

(57) ABSTRACT

An antenna device for supporting a plurality of bands in a portable terminal includes a supporting part having an antenna member comprises of a compressed coil, so that the interlayer interval is changed according to the length variation of the supporting part.

### CLAIM OF PRIORITY

This application claims the benefit of the earlier filling data, under 35 U.S.C. §119, from patent application Serial No. 10-2011-0074909 filed in the Korean Intellectual Property Office on Jul. 28, 2011, the contents of which are incorporated by reference in its entirety.

### BACKGROUND OF THE INVENTION

1. Field of the Invention

The present invention relates to a portable terminal.

2. Description of the Related Art

In today's society, portable terminals become necessities of modern people due to their convenience and portability. Therefore, service providers and terminal manufacturers attempt to provide extra functions, such as a TV broadcasting, to further increase the utilization of the portable terminal.

When a TV broadcasting service is deployed, it's common that the portable terminal is provided with a separate external antenna for receiving TV broadcasting. Currently serviced TV broadcasting is provided by a digital TV scheme and an analog TV scheme through different frequency bands.

A length of an antenna required to receive TV broadcasting differs due to the different frequency bands of the digital TV scheme and the analog TV scheme. If only an antenna fixed by one length is used, the quality of each of TV broadcasting services of two schemes may differ. Accordingly, when both the digital TV broadcasting and analog TV broadcasting are serviced, two reception antennas optimized for each band are needed. However, the provision of a plurality of reception antennas results in an increase in the manufacturing cost and undesirably increases the size of a portable terminal.

Accordingly, there is a need to service both the digital TV broadcasting and the analog TV broadcasting without increasing the number of antennas required.

### SUMMARY OF THE INVENTION

An aspect of the present invention is to address at least the above-mentioned problems and/or disadvantages and to provide at least the advantages described below. Accordingly, an aspect of the present invention is to provide an apparatus for servicing both the digital TV broadcasting and the analog TV broadcasting without increasing the number of antennas.

Another aspect of the present invention is to provide an apparatus for receiving signals of different bands through a single antenna in a portable terminal.

In accordance with an aspect of the present invention, an antenna device includes a supporting part whose length is expandably adjustable in at least two stages, and a coil, disposed in the supporting part, whose interlayer interval is selectively changed according to the length of the supporting part.

In accordance with an aspect of the present invention, an antenna device includes an expandable antenna adjustable to a first antenna mode and a second antenna mode; and a coil disposed inside the expandable antenna in a compressed form during the first antenna mode and in a decompressed form during the second antenna mode, wherein a resonant frequency of the antenna is changed according to the first antenna mode or the second antenna mode. More specifically, a resonant frequency of the antenna is identical to an analog TV broadcasting frequency band during the first antenna mode, and identical to a digital TV broadcasting frequency band during the second antenna mode.

Other exemplary aspects, advantages and salient features of the invention will become more apparent to those skilled in the art from the following detailed description, which, taken in conjunction with the annexed drawings, discloses exemplary embodiments of the invention in more detail.

### BRIEF DESCRIPTION OF THE DRAWINGS

The above features and advantages of certain exemplary embodiments of the present invention will become more apparent from the following detailed description when taken in conjunction with the accompanying drawings, in which:

FIGS. 1a and 1b illustrate an antenna structure of a portable terminal according to an embodiment of the present invention;

FIGS. 2a to 2d illustrate an adjustment process of an antenna of a portable terminal according to an embodiment of the present invention;

FIGS. 3a and 3b illustrate an antenna attachment state of a portable terminal according to an embodiment of the present invention; and

FIGS. 4a and 4b are waveform charts illustrating frequency characteristics according to an expansion state of an antenna of a portable terminal according to an embodiment of the present invention.

Throughout the drawings, like reference numerals will be understood to refer to like parts, components and structures.

### DETAILED DESCRIPTION

Exemplary embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

The present invention relates to an antenna device for supporting a plurality of bands in a portable terminal.

Hereinafter, a description will be given with respect to technology for receiving signals of different bands through a single antenna in a portable terminal according to an embodiment of the present invention. The teachings of the present invention eliminates the need for having a plurality of antennas for supporting both the digital TV broadcasting and analog TV broadcasting in the past. However, the prevent invention is not limited to application in which the digital TV broadcasting and the analog TV broadcasting are received. If a portable terminal is in an environment where signals of different bands must be received, the teachings of the present invention may be equally applied in such environment.

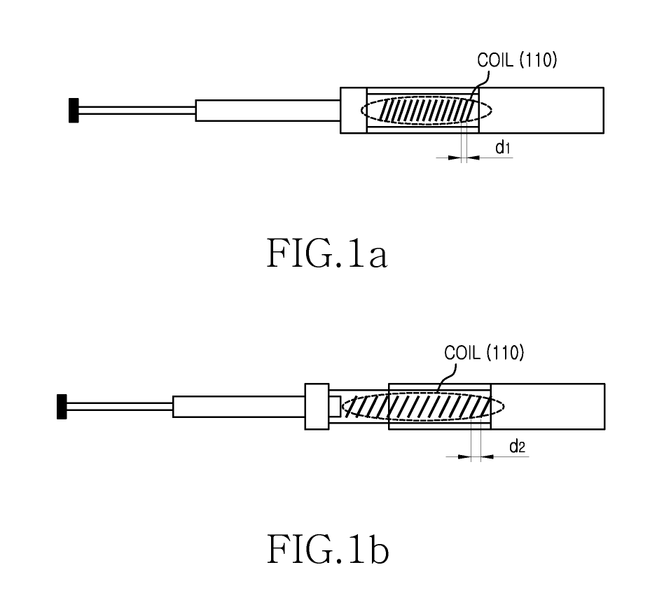

FIGS. 1a and 1b illustrates an antenna structure of a portable terminal according to an embodiment of the present invention.

Referring to FIGS. 1a and 1b, an antenna includes a coil 110 of the same structure as a helical antenna having a metal line wound into a spiral.

As shown, it is possible to selectively adjust a length of the antenna, for example, in two stages. FIG. 1a illustrates a primarily expanded state of the antenna, and FIG. 1b illustrates a secondarily expanded state of the antenna. When the antenna is primarily expanded, an interlayer interval of the coil 110 is d₁. When the antenna is secondarily expanded, the interlayer interval of the coil 110 is increased to d₂. For this reason, an inductance value of the coil 110 is reduced, and a resonant frequency is heightened. Accordingly, when the antenna is secondarily expanded, it is optimized to receive a signal of a frequency band which is higher than a frequency band of a signal when it is primarily expanded.

In accordance with the above-described principle, an antenna optimized to receive signals of different bands according to an expansion state may be configured by designing the antenna to be identical to a frequency of a signal for receiving resonant frequencies when the antenna is primarily and secondarily expanded. For example, the antenna may be designed to have resonant frequency values optimized to receive an analog TV signal when the antenna is primarily expanded and to receive a digital TV signal when the antenna is secondarily expanded.

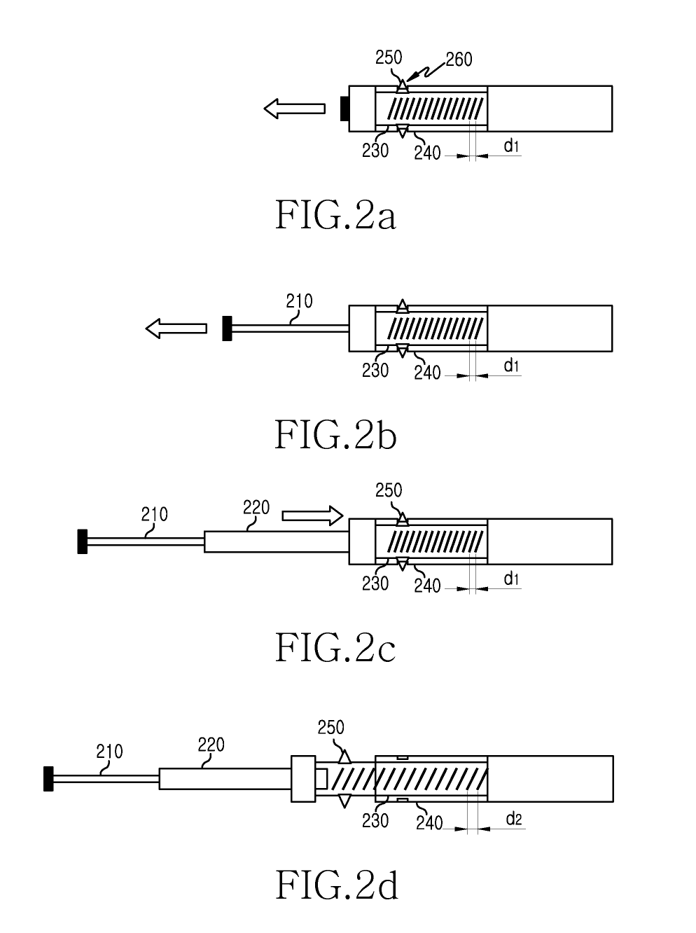

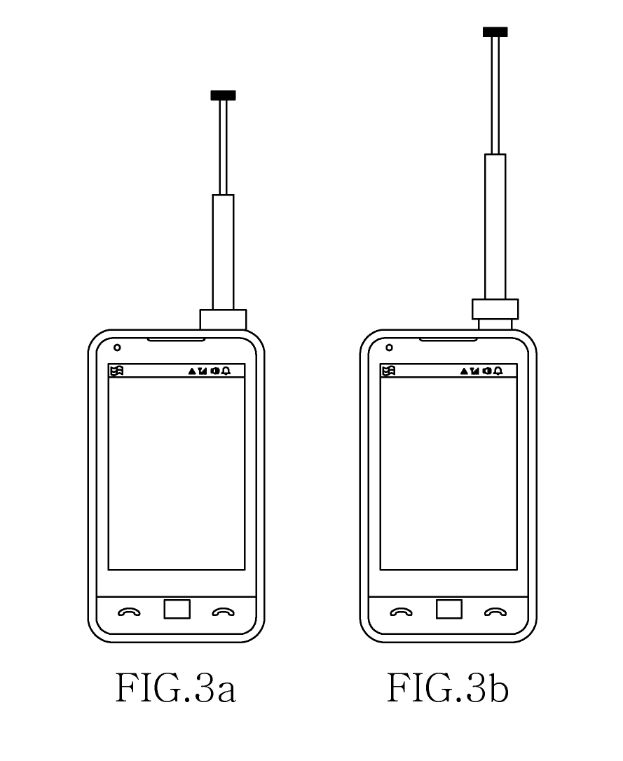

FIGS. 2a to 2d illustrate an adjustment process of antenna of a portable terminal according to an embodiment of the present invention.

A coil of the antenna is disposed in a supporting part. It is possible to variably adjust a length of the supporting part. For example, the supporting part includes an inner wall 230 and an outer wall 240. A protrusion 250 is attached on the inner wall 230. The protrusion 250 is fixed by a hanging hole 260 formed in the outer wall 240. A boundary between a first primary expansion state and a secondary expansion state is determined at a point where the protrusion 250 is fixed by the hanging hole 260. If the protrusion 250 gets out of the hanging hole 260 in the primary expansion state and the part or all of the inner wall 230 is escaped from the outer wall 240, the antenna is in a secondary expansion state illustrated in FIG. 1b. For example, motion and locking/unlocking mode in which the protrusion 250 gets out of the hanging hole 260 may be performed by a similar principle of that of a knock-type ball-point pen.

FIG. 2a illustrates a state where the antenna is initially folded. If a user of the portable terminal provides a force pulling the antenna in an arrow direction shown in FIG. 2a, a first stage 210 of the antenna is exposed to the outside as shown in FIG. 2b. If the user provides a force pulling the antenna in an arrow direction shown in FIG. 2c, a second stage 220 is exposed to the outside as shown in FIG. 2c. FIG. 2c illustrates a primary expansion state. At this state, the antenna is optimized to receive a signal of a first frequency band in the primary expansion state. In FIGS. 2a to 2c, because the inner wall 230 is not moved, a state of the coil is not changed. In other words, an interlayer interval of the coil is maintained as d₁, and a resonant frequency of the coil is not changed.

In the primary expansion state, if the user provides a force in an arrow direction shown in FIG. 2c, the protrusion 250 gets outs of the hanging hole 260. For example, a motion in which the protrusion 250 gets out of the hanging hole 260 may be performed by a similar principle of that of a knock-type ball-point pen. As shown FIG. 2d, the inner wall 230 is escaped from the outside wall 240 by elasticity of the coil and the antenna is secondarily expanded. For this reason, the interlayer interval of the coil is increased to d₂. FIG. 2d illustrates a secondary expansion state. The antenna is optimized to receive a signal of a second frequency band in the secondary expansion state. In that, the primary expansion state is a state where the coil is compressed, and the second expansion state is a state where the coil is decompressed.

In one embodiment of the present invention described with reference to FIGS. 2a to 2d, motion in which the protrusion 250 gets out of the hanging hole 260 is performed by providing a force in the arrow direction shown in FIG. 2c. However, in accordance with another embodiment of the present invention, a part to which the force is provided such that the protrusion 250 gets out of the hanging hole 260 may be differently positioned. For example, the force may be directly provided to the protrusion 250 such that the protrusion 250 gets out of the hanging hole 260. Alternatively, the force of a threshold value or more may be provided in an arrow direction shown in (b) of FIG. 2 such that the protrusion 250 gets out of the hanging hole 260.

FIGS. 3a and 3b illustrates an antenna attachment state of a portable terminal according to an embodiment of the present invention.

Referring to FIGS. 3a and 3b, when a signal of a first frequency band is received, a user of the portable terminal, as shown in FIG. 3a, may fit a resonant frequency of an antenna to a first frequency band by primarily expanding the antenna. On the other hand, when a signal of a second frequency band which is relatively higher than the first frequency band, the user may fit a resonant frequency of the antenna to the second frequency band by secondarily expanding the antenna, as shown in FIG. 3b.

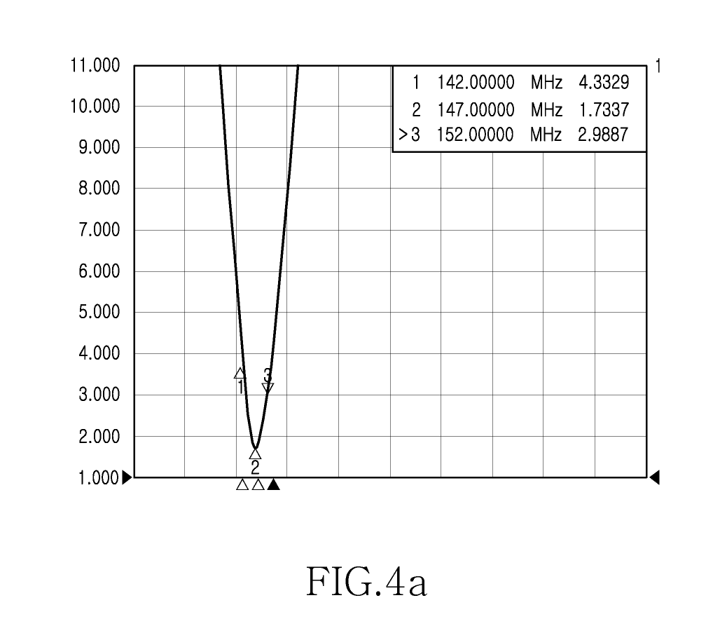

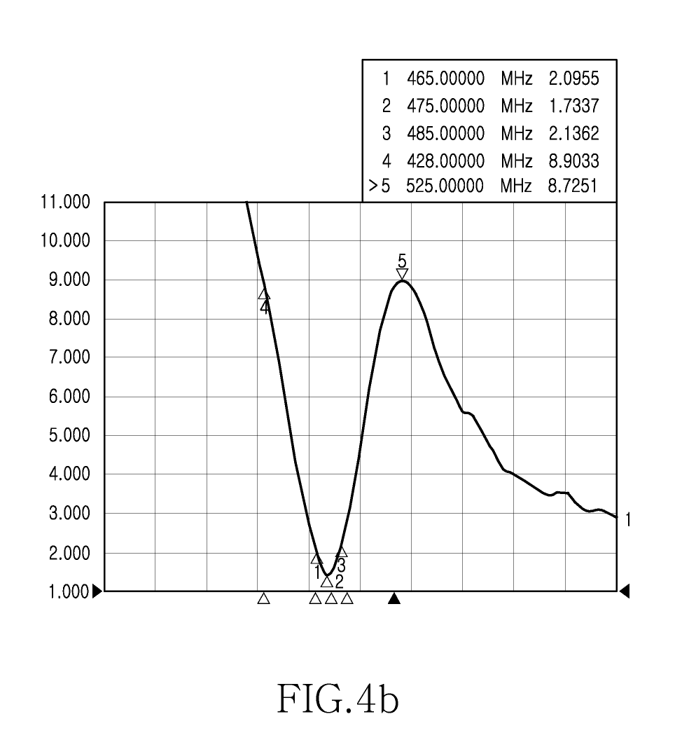

A frequency characteristic of the antenna of a state shown in FIG. 3a is shown in FIG. 4a. A frequency characteristic of the antenna of a state shown in FIG. 3b is shown in FIG. 4b.

In FIGS. 4a and 4b, a horizontal axis denotes a frequency and a vertical axis denotes an antenna reflection coefficient. as shown, the antenna shown in FIG. 3a has the lowest reflection coefficient at 147 MHz. The antenna shown in FIG. 3b has the lowest reflection coefficient at 475 MHz. Thus, frequencies having the lowest reflection coefficients according to an expansion state of the antenna, namely, resonant frequencies, differs from each other.

Accordingly, the portable terminal may receive different frequencies effectively by selectively adjusting a length of the antenna according to a frequency band of a signal to be received. Thus, the portable terminal may receive both an analog TV signal and a digital TV signal effectively to enjoy broadcasting service of both signals.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An antenna device comprising:
a supporting part whose length is expandably adjustable in at least two stages; and
a coil, disposed in the supporting part, whose interlayer interval is selectively changed according to the length of the supporting part.

2. The antenna device of claim 1, wherein a resonant frequency of the antenna is changed according to the change of the interlayer interval of the coil.

3. The antenna device of claim 1, wherein the supporting part includes an outer wall and an inner wall, and
wherein the length of the supporting part is increased when a part or all of the inner wall is escaped from the outer wall and.

4. The antenna device of claim 3, wherein the supporting part further includes a protrusion coupled to the inner wall, and a hanging hole formed in the outer wall for releasably locking the protrusion.

5. The antenna device of claim 4, wherein the inner wall is escaped from the outer wall by elasticity of the coil generated when the protrusion is released from the hanging hole.

6. The antenna device of claim 1, wherein the interlayer interval of the coil is selectively changed to a first size and a second size,
wherein a resonant frequency of the antenna is identical to an analog TV broadcasting frequency band when the interlayer interval is the first size, and
wherein a resonant frequency of the antenna is identical to a digital TV broadcasting frequency band when the interlayer interval is the second size.

7. The antenna device of claim 6, wherein the first size is the interlayer interval when the coil is compressed, and
wherein the second size is the interlayer interval when the coil is decompressed.

8. An antenna device comprising:
an expandable antenna adjustable to a first antenna mode and a second antenna mode; and
a coil disposed inside the expandable antenna in a compressed form during the first antenna mode and in a decompressed form during the second antenna mode.

9. The antenna device of claim 8, wherein a resonant frequency of the antenna is changed according to the first antenna mode or the second antenna mode.

10. The antenna device of claim 8, wherein a resonant frequency of the antenna is identical to an analog TV broadcasting frequency band during the first antenna mode.

11. The antenna device of claim 8, wherein a resonant frequency of the antenna is identical to a digital TV broadcasting frequency band during the second antenna mode.
